(19) United States
(12) Patent Application Publication
(10) Pub. No.: US 2024/0304899 A1
(43) Pub. Date: Sep. 12, 2024

(54) BATTERY PACK

(71) Applicant: HONDA MOTOR CO., LTD., Tokyo (JP)

(72) Inventors: Tsutomu YOSHINO, Saitama (JP); Kenichi SHIRAKI, Saitama (JP); Keiji TADA, Saitama (JP)

(73) Assignee: HONDA MOTOR CO., LTD., Tokyo (JP)

(21) Appl. No.: 18/590,086

(22) Filed: Feb. 28, 2024

(30) Foreign Application Priority Data
Mar. 8, 2023 (JP) 2023-035932

(51) Int. Cl. H01M 10/6568; B60K 11/04; B60L 50/64; H01M 10/613; H01M 10/625; H01M 50/209; H01M 50/249

(52) U.S. Cl. CPC H01M 10/6568; B60L 50/64; H01M 10/613; H01M 10/625; H01M 50/209; H01M 50/249; B60K 11/04; H01M 2220/20

(57) ABSTRACT

A battery pack is mounted on a vehicle. The battery pack has a case, battery modules placed on the case, battery cooling portions through which a refrigerant flows, a distribution pipe, and an aggregation pipe. Each battery cooling portion includes a refrigerant jacket cooling the battery modules arranged side by side in a front-rear direction of the vehicle, a supply pipe suppling the refrigerant to the refrigerant jacket, and a discharge pipe discharging the refrigerant from the refrigerant jacket. The refrigerant jacket, the supply pipe and the discharge pipe each have a flat shape being short in an upper-lower direction. The supply pipe and the discharge pipe are arranged below the refrigerant jacket. The supply pipe is connected to a supply port provided in a central portion of the refrigerant jacket. The discharge pipe is connected to a discharge port provided in the central portion of the refrigerant jacket.

### CROSS-REFERENCE TO RELATED APPLICATIONS

This application is based on and claims priority under 35 USC 119 from Japanese Patent Application No. 2023-035932 filed on Mar. 8, 2023, the entire content of which is incorporated herein by reference.

### TECHNICAL FIELD

The present disclosure relates to a battery pack to be mounted on a vehicle.

### BACKGROUND ART

In recent years, researches and developments have been conducted on a secondary battery (hereinafter, also referred to as a battery) that contributes to improvement in energy efficiency in order to allow more users to access affordable, reliable, sustainable, and advanced energy.

A large-capacity battery is mounted on a vehicle such as a battery type electric automobile, a hybrid vehicle, or a fuel cell vehicle. Since the battery mounted on such a vehicle generates a large amount of heat, a cooling mechanism for cooling the battery is provided in view of safety and prevention of deterioration. For example, JP2019-086183A discloses a heat transfer device in which a flat tube through which a heat transfer medium flows are arranged below a plurality of battery packs, and the plurality of battery packs are simultaneously cooled.

In JP2019-086183A, an inlet member and an outlet member through which a heat transfer medium flows in and out are provided in a central portion of the flat tube in a longitudinal direction. By allowing a refrigerant to flow in and out from the central portion of the flat tube, it is possible to prevent a variation in temperatures of the plurality of battery packs.

However, in JP2019-086183A, the central portion of the flat tube is located between the adjacent battery packs, and an inflow pipe and an outflow pipe connected to the inlet member and the outlet member are attached from above in a space between the adjacent battery packs. According to such a configuration, the layout of various components (for example, a plurality of battery packs, a connection member connecting the battery packs, and the like) mounted on the battery pack may be more limited to the inflow pipe and the outflow pipe.

### SUMMARY OF INVENTION

The present disclosure provides a battery pack with improved an internal layout performance while preventing a variation in temperature of a plurality of battery modules. This contributes to improvement in energy efficiency.

An aspect of the present disclosure relates to a battery pack to be mounted on a vehicle, the battery pack having:
a battery case;
a plurality of battery modules placed on the battery case such that a longitudinal direction of each of the battery modules is a front-rear direction of the vehicle, at least two battery modules being arranged side by side in a vehicle width direction, and at least two battery modules being arranged side by side in the front-rear direction;
a plurality of battery cooling portions, through which a refrigerant flows, arranged below the at least two battery modules arranged side by side in the front-rear direction;
a distribution pipe arranged on one side in the front-rear direction with respect to the plurality of battery modules and configured to distribute the refrigerant to the plurality of battery cooling portions; and
an aggregation pipe arranged on other side in the front-rear direction with respect to the plurality of battery modules and configured to aggregate the refrigerant discharged from the plurality of battery cooling portions,
in which each of the plurality of battery cooling portions includes:
   a refrigerant jacket configured to cool the at least two battery modules arranged side by side in the front-rear direction;
   a supply pipe connected to the refrigerant jacket and the distribution pipe, and configured to supply the refrigerant to the refrigerant jacket; and
   a discharge pipe connected to the refrigerant jacket and the aggregation pipe, and configured to discharge the refrigerant from the refrigerant jacket,
in which the refrigerant jacket, the supply pipe, and the discharge pipe each have a flat shape that is short in an upper-lower direction,
in which the supply pipe is arranged below the refrigerant jacket, and is connected to a supply port provided in a central portion of the refrigerant jacket in the front-rear direction, and
in which the discharge pipe is arranged below the refrigerant jacket, and is connected to a discharge port provided in the central portion of the refrigerant jacket.

According to the present disclosure, it is possible to improve the internal layout performance while preventing a variation in temperature of the plurality of battery modules.

### BRIEF DESCRIPTION OF DRAWINGS

Exemplary embodiment(s) of the present invention will be described in detail based on the following figures, wherein:

FIG. 1 is a schematic side view showing an overall structure of a vehicle 1 in which a battery pack 7 according to an embodiment of the present disclosure is mounted;

FIG. 2 is a perspective view showing an internal structure of the battery pack 7;

FIG. 3 is a perspective view of a battery cooling mechanism 40;

FIG. 4 is a perspective view of the battery cooling mechanism 40 as viewed from below;

FIG. 5 is a view showing a battery module 31 and a battery cooling portion 41 arranged below the battery module 31 in a cross section taken along a line A-A of FIG. 3;

FIG. 6 is a perspective view taken along the line A-A of FIG. 3;

FIG. 7 is a perspective view taken along a line B-B of FIG. 3;

FIG. 8 is a perspective view taken along a line C-C of FIG. 3;

FIG. 9 is a perspective view taken along a line D-D of FIG. 3; and

FIG. 10 is a perspective view taken along a line E-E of FIG. 3.

### DESCRIPTION OF EMBODIMENTS

Hereinafter, an embodiment of a battery pack of the present disclosure will be described with reference to the accompanying drawings. Note that the drawings are viewed in directions of reference numerals, directions such as front, rear, left, right, upper, and lower directions are described according to a direction viewed from a driver of a vehicle. In the drawings, a front side of the vehicle is denoted by Fr, a rear side thereof is denoted by Rr, a left side thereof is denoted by L, a right side thereof is denoted by R, an upper side thereof is denoted by U, and a lower side thereof is denoted by D. A left-right direction is also referred to as a vehicle width direction.

### Vehicle

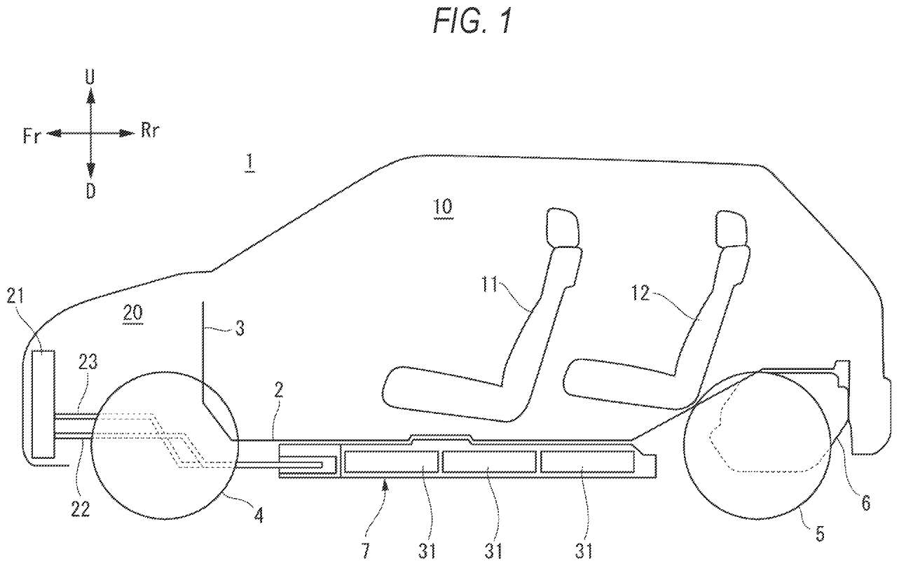

FIG. 1 shows a vehicle 1 on which a battery pack 7 according to an embodiment of the present disclosure is mounted. The vehicle 1 is an electric vehicle such as a battery type electric automobile. The vehicle 1 is partitioned into a vehicle compartment 10 and a front room 20 in front of the vehicle compartment 10 by a floor panel 2 and a dash panel 3. A front seat 11 and a rear seat 12 are provided in the vehicle compartment 10.

A drive unit 6 is provided below the floor panel 2 behind the rear seat 12. Although not shown, the drive unit 6 includes a motor, a power control unit (PCU) that controls the motor, and a power transmission mechanism that transmits power of the motor to rear wheels 5. The drive unit 6 drives left and right rear wheels 5. The vehicle 1 has left and right rear wheels 5 as drive wheels and left and right front wheels 4 as driven wheels.

The battery pack 7 according to an embodiment of the present disclosure is arranged below the vehicle compartment 10. The battery pack 7 is arranged below the floor panel 2 in the vehicle compartment 10. Details of the battery pack 7 will be described later.

There is a cooling device 21 that cools the battery pack 7 and the like in the front room 20. The cooling device 21 includes a radiator provided on the foremost surface of the vehicle 1. The cooling device 21 and the battery pack 7 are connected via an outer supply pipe 22 and an outer discharge pipe 23. An electric pump (not shown) is provided in the outer supply pipe 22 or the outer discharge pipe 23.

### Battery Pack

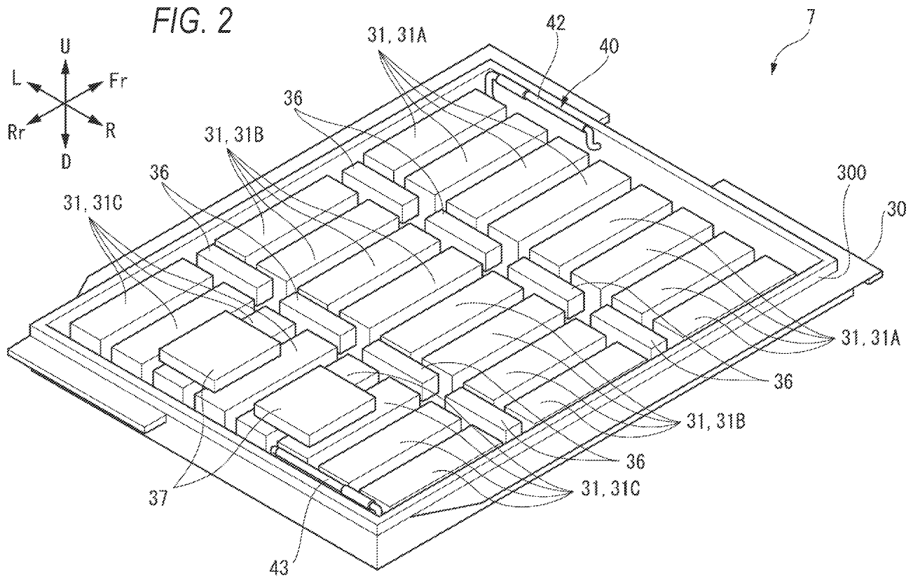

Next, the battery pack 7 will be described with reference to FIGS. 2 to 10. The battery pack 7 includes a battery case 30, a plurality of battery modules 31, and a battery cooling mechanism 40.

As shown in FIG. 2, the battery case 30 accommodates the plurality of battery modules 31 and the battery cooling mechanism 40. The battery case 30 includes a case main body 300 on which the plurality of battery modules 31 and the battery cooling mechanism 40 are placed, and a cover (not shown) that covers the case main body 300 from above.

The plurality of battery modules 31 store electric power to be supplied to the drive unit 6 serving as a drive source of the vehicle 1. The plurality of battery modules 31 are placed on the battery case 30 such that a longitudinal direction is the front-rear direction. In the present embodiment, eight battery modules 31 are arranged side by side in the vehicle width direction and three battery modules 31 are arranged side by side in the front-rear direction, that is, a total of 24 battery modules 31 are arranged. In the following description, the eight battery modules located at the front row may be referred to as battery modules 31A, the eight battery modules located at the rear row may be referred to as battery modules 31C, and the eight battery modules located between the front battery modules 31A and the rear battery modules 31C, that is, at the center, may be referred to as battery modules 31B. The number of battery modules 31 is any, and at least two battery modules 31 may be arranged in the vehicle width direction and at least two battery modules 31 may be arranged in the front-rear direction.

Between the front battery modules 31A and the central battery modules 31B and between the central battery modules 31B and the rear battery modules 31C, there are provided cross members (not shown) extending in the left-right direction from a left side wall to a right side wall of the case main body 300. A wiring component 36 is provided at an upper portion of the cross member. The wiring component 36 includes, for example, a bus bar connecting the battery modules 31 and an ECU connector unit connected to a battery electronic control unit (ECU) (not shown). A junction board 37 is arranged above a part of the battery modules 31C at the rear row. Various wirings are mounted on the junction board 37, and the junction board 37 is electrically connected to an external device (not shown).

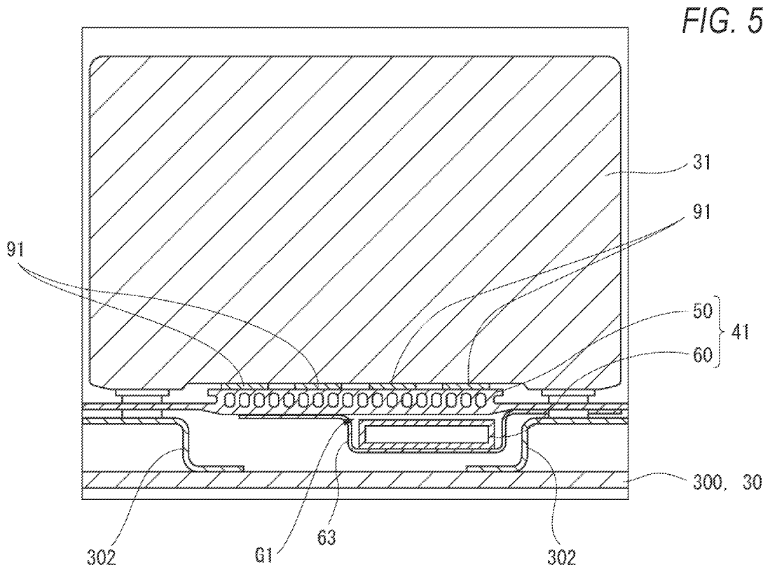

As shown in FIG. 5, the plurality of battery modules 31 are supported by a battery support bracket 302 provided on a bottom surface of the case main body 300. By the battery support bracket 302, a space in which a battery cooling portion 41 to be described later can be arranged is formed between the lower surfaces of the plurality of battery modules 31 and the bottom surface of the case main body 300.

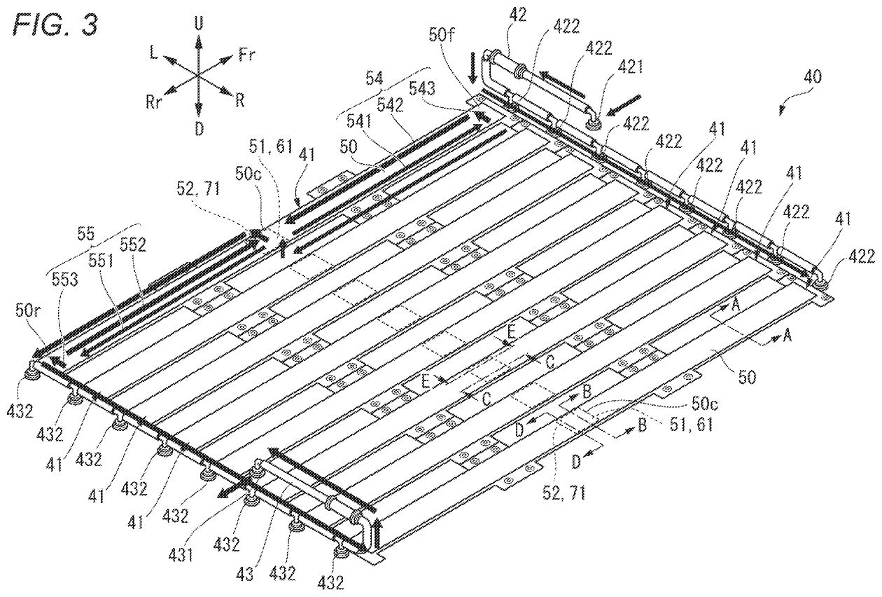

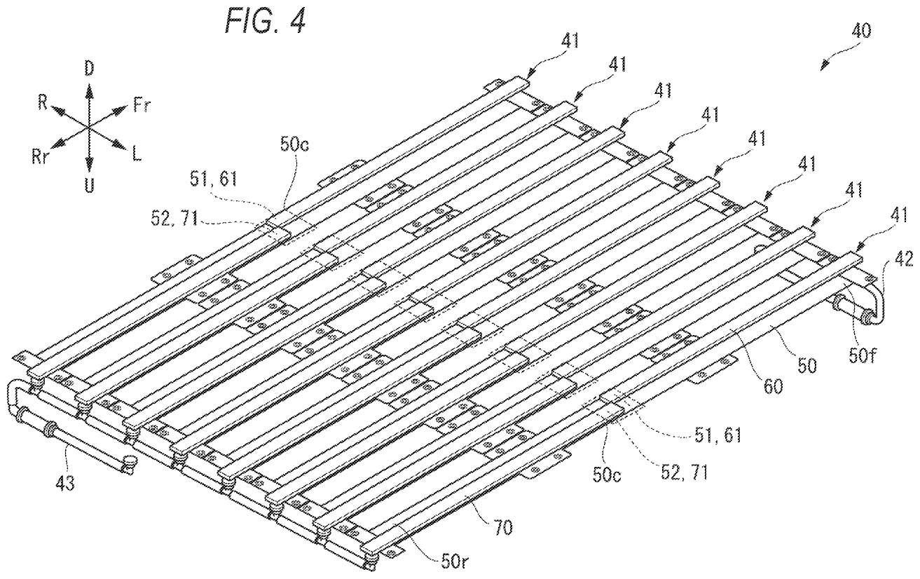

The battery cooling mechanism 40 cools the plurality of battery modules 31. As shown in FIGS. 3 and 4, the battery cooling mechanism 40 includes a plurality of battery cooling portions 41, a distribution pipe 42, and an aggregation pipe 43.

A refrigerant (for example, cooling water) flows through the plurality of battery cooling portions 41 to cool the plurality of battery modules 31. The eight battery cooling portions 41 are arranged side by side in the vehicle width direction. The battery cooling portions 41 are arranged below the three battery modules 31 arranged side by side in the front-rear direction, that is, the battery modules 31A, 31B and 31C (see FIG. 5).

As shown in FIGS. 2 to 4, the distribution pipe 42 is arranged in front of the plurality of battery modules 31 and distributes the refrigerant to the plurality of battery cooling portions 41. The distribution pipe 42 includes an outer connection portion 421 connected to the outer supply pipe 22 and a plurality of inner connection portions 422 respectively connected to the plurality of battery cooling portions 41. The refrigerant is introduced into the distribution pipe 42 from the outer connection portion 421, and the refrigerant is distributed from the inner connection portion 422 to the plurality of battery cooling portions 41.

The aggregation pipe 43 is arranged behind the plurality of battery modules 31 and aggregates the refrigerant discharged from the plurality of battery cooling portions 41. The aggregation pipe 43 includes an outer connection portion 431 connected to the outer discharge pipe 23 and a plurality of inner connection portions 432 respectively connected to the plurality of battery cooling portions 41. The refrigerant discharged from the plurality of battery cooling portions 41 is introduced into the aggregation pipe 43 from the inner connection portions 432, and the refrigerant is discharged from the outer connection portion 431 to the outer discharge pipe 23. The refrigerant discharged from the aggregation pipe 43 to the outer discharge pipe 23 is cooled by the cooling device 21, and then supplied again to the plurality of battery cooling portions 41 through the outer supply pipe 22 and the distribution pipe 42.

### Battery Cooling Portion

Next, each battery cooling portion 41 will be described in detail. Each battery cooling portion 41 includes a refrigerant jacket 50, a supply pipe 60, and a discharge pipe 70. The battery cooling portions 41 have the same configuration.

The refrigerant jacket 50 has a flat shape that is short in an upper-lower direction. The refrigerant jackets 50 are arranged below the three battery modules 31 (that is, the battery modules 31A, 31B and 31C) arranged side by side in the front-rear direction, and cools the three battery modules 31. More specifically, as shown in FIG. 5, the refrigerant jacket 50 is arranged below the battery module 31 via a heat transfer member 91. The refrigerant jackets 50 extend in the front-rear direction along lower surfaces of the three battery modules 31, and the battery modules 31 are cooled by heat exchange between the refrigerant flowing through the refrigerant jackets 50 and the battery modules 31.

As shown in FIGS. 3 to 4 and 7 to 10, the refrigerant jacket 50 has a supply port 51 and a discharge port 52 provided in a central portion 50c in the front-rear direction. The supply port 51 and the discharge port 52 are open downward. In addition, the supply port 51 and the discharge port 52 are spaced apart from each other in the left-right direction and the front-rear direction. The supply port 51 is a refrigerant inlet that is connected to the supply pipe 60 and introduces the refrigerant from the supply pipe 60 to the refrigerant jacket 50. The discharge port 52 is a refrigerant outlet that is connected to the discharge pipe 70 and discharges the refrigerant from the refrigerant jacket 50 to the discharge pipe 70.

A plurality of flow paths 53 extending in the front-rear direction are formed inside the refrigerant jacket 50. The refrigerant introduced into the refrigerant jacket 50 from the supply port 51 flows through the plurality of flow paths 53 and is discharged from the discharge port 52.

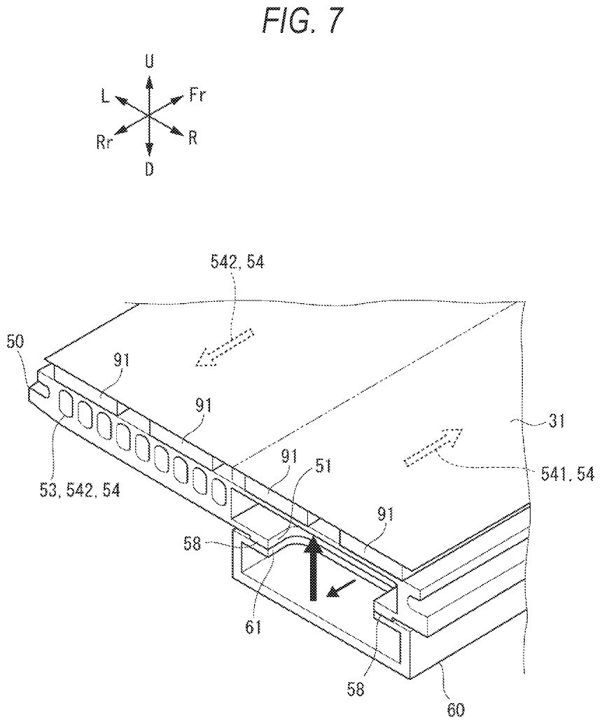

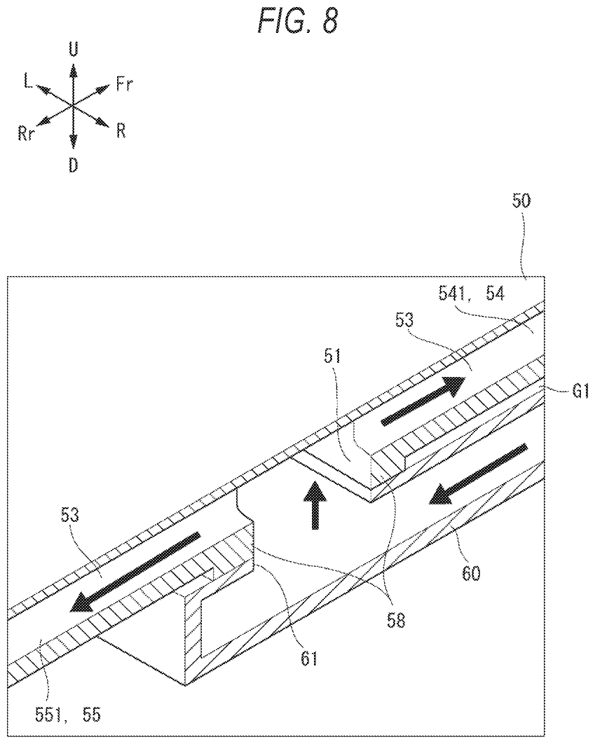

As shown in FIG. 4, the supply pipe 60 is connected to the refrigerant jacket 50 and the distribution pipe 42, and supplies the refrigerant to the refrigerant jacket 50. The supply pipe 60 has a flat shape that is short in the upper-lower direction. As shown in FIGS. 7 and 8, the supply pipe 60 is arranged below the refrigerant jacket 50, and is connected to the supply port 51 provided in the central portion 50c of the refrigerant jacket 50 as described above. Specifically, an opening 61 that is open upward is provided in an upper surface of the supply pipe 60, and the opening 61 is connected to the supply port 51 of the refrigerant jacket 50. As shown in FIG. 5, the supply pipe 60 is supported by a pipe support bracket 63 connected to a lower surface of the refrigerant jacket 50. Although not shown, a plurality of pipe support brackets 63 are provided to support the supply pipe 60 extending in the front-rear direction from below.

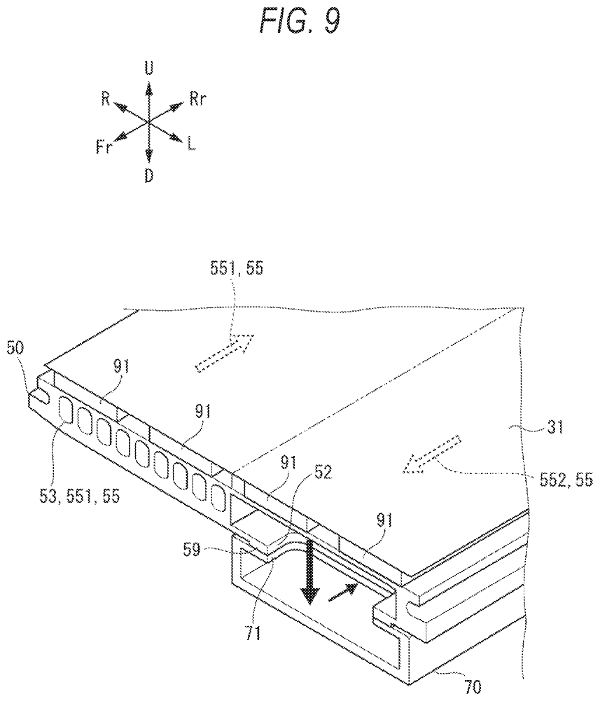

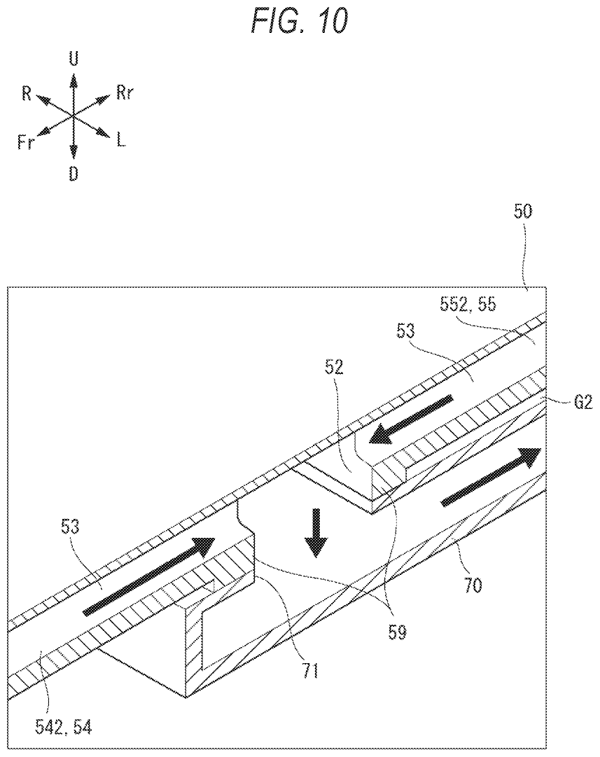

As shown in FIG. 4, the discharge pipe 70 is connected to the refrigerant jacket 50 and the aggregation pipe 43, and discharges the refrigerant from the refrigerant jacket 50. The discharge pipe 70 has a flat shape that is short in the upper-lower direction. As shown in FIGS. 9 and 10, the discharge pipe 70 is arranged below the refrigerant jacket 50, and is connected to the discharge port 52 provided in the central portion 50c of the refrigerant jacket 50 as described above. Specifically, an opening 71 that is open upward is provided on an upper surface of the discharge pipe 70, and the opening 71 is connected to the discharge port 52 of the refrigerant jacket 50. Although not shown, similarly to the supply pipe 60, the discharge pipe 70 is supported by a pipe support bracket connected to the lower surface of the refrigerant jacket 50. A plurality of pipe support brackets are provided to support the discharge pipe 70 extending in the front-rear direction from below.

As shown in FIG. 3, the refrigerant flowing through the supply pipe 60 is introduced into the refrigerant jacket 50 from the supply port 51 provided in the central portion 50c, and then flows from the central portion 50c of the refrigerant jacket 50 toward a front end portion 50f and a rear end portion 50r to cool the three battery modules 31 arranged side by side in the front-rear direction. The refrigerant is discharged from the discharge port 52 provided in the central portion 50c to the discharge pipe 70. Since the supply port 51 and the discharge port 52 are provided in the central portion 50c of the refrigerant jacket 50, the three battery modules 31 arranged side by side in the front-rear direction can be uniformly cooled, and a variation in temperature can be prevented.

Since the supply pipe 60 and the discharge pipe 70 have a flat shape that is short in the upper-lower direction, the supply pipe 60 and the discharge pipe 70 can be arranged in a narrow space below the battery module 31. With such a configuration, the supply pipe 60 and the discharge pipe 70 do not interfere with the battery module 31, the wiring component 36, and the like, and a layout performance inside the battery pack 7 can be improved. Further, since the supply pipe 60 and the discharge pipe 70 are arranged below the battery module 31, even when the supply pipe 60 and the discharge pipe 70 are temporarily damaged and the refrigerant leaks, it is possible to avoid scattering of the refrigerant to the battery module 31, the wiring component 36, and the like.

As described above, since connection between the supply pipe 60 and the refrigerant jacket 50 is performed by connecting the opening 61 provided in the upper surface of the supply pipe 60 to the supply port 51 of the refrigerant jacket 50, a height in the upper-lower direction of the connection portion between the refrigerant jacket 50 and the supply pipe 60 can be reduced. Similarly, in the discharge pipe 70, since the opening 71 provided in the upper surface of the discharge pipe 70 is connected to the discharge port 52 of the refrigerant jacket 50, a height in the upper-lower direction of the connection portion between the refrigerant jacket 50 and the discharge pipe 70 can be reduced.

Next, a flow of the refrigerant in the refrigerant jacket 50 will be described in detail with reference to FIGS. 3 and 7 to 10. The refrigerant jacket 50 has a front flow path 54 and a rear flow path 55.

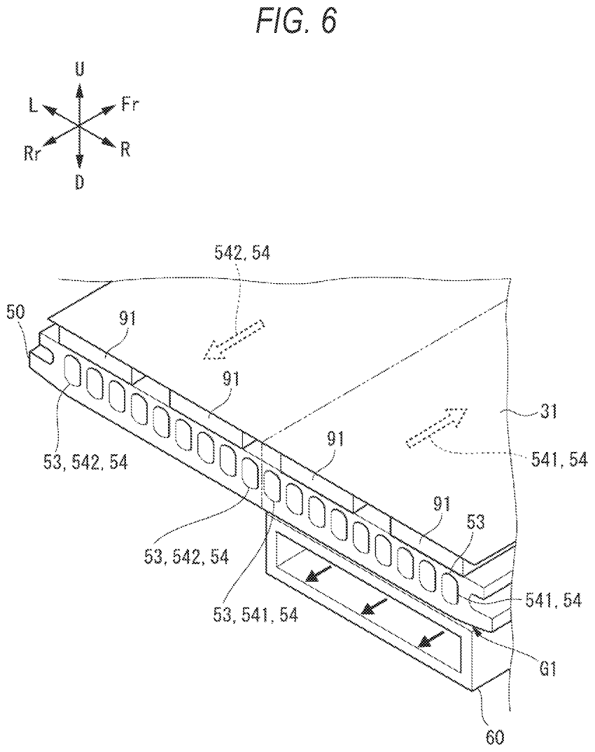

As shown in FIG. 3, the front flow path 54 allows the refrigerant introduced from the supply port 51 provided in the central portion 50c to flow to the front end portion 50f, and allows the refrigerant to return at the front end portion 50f and to flow from the front end portion 50f to the discharge port 52 provided in the central portion 50c. Specifically, the front flow path 54 has a substantially U-shape in a top view, and includes an upstream side straight flow path 541 extending from the supply port 51 of the central portion 50c to the front end portion 50f, a downstream side straight flow path 542 extending from the discharge port 52 of the central portion 50c to the front end portion 50f, and a return portion 543 connecting the upstream side straight flow path 541 and the downstream side straight flow path 542 to change the flow of the refrigerant from a front direction to a rear direction. In FIGS. 6 and 7, a boundary between the upstream side straight flow path 541 and the downstream side straight flow path 542 is indicated by a two-dot chain line.

In the present embodiment, the front flow path 54 cools the front battery modules 31A at the front row and the central battery modules 31B at the center among the three battery modules 31A, 31B and 31C arranged side by side in the front-rear direction.

As shown in FIG. 3, the rear flow path 55 allows the refrigerant introduced from the supply port 51 provided in the central portion 50c to flow to the rear end portion 50r, and allows the refrigerant to return at the rear end portion 50r and to flow from the rear end portion 50r to the discharge port 52 provided in the central portion 50c. Specifically, the rear flow path 55 has a substantially U-shape in a top view, and includes an upstream side straight flow path 551 extending from the supply port 51 of the central portion 50c to the rear end portion 50r, a downstream side straight flow path 552 extending from the discharge port 52 of the central portion 50c to the rear end portion 50r, and a return portion 553 connecting the upstream side straight flow path 551 and the downstream side straight flow path 552 to change the flow of the refrigerant from the rear direction to the front direction. In FIG. 9, a boundary between the upstream side straight flow path 551 and the downstream side straight flow path 552 is indicated by a two-dot chain line.

In the present embodiment, the rear flow path 55 cools the central battery modules 31B at the center and the rear battery modules 31C at the rear row among the three battery modules 31A, 31B and 31C arranged side by side in the front-rear direction.

As described above, since the refrigerant jacket 50 has the front flow path 54 and the rear flow path 55 having a substantially U-shape in a top view, the three battery modules 31A, 31B and 31C arranged side by side in the front-rear direction can be uniformly cooled, and a variation in temperature can be prevented.

Here, as shown in FIG. 8, a gap G1 is formed between the refrigerant jacket 50 and the supply pipe 60. A step portion 58 is provided around the supply port 51 of the refrigerant jacket 50, and the step portion 58 around the supply port 51 abuts against the upper surface of the supply pipe 60 to form the gap G1.

The refrigerant flowing through the refrigerant jacket 50 exchanges heat with the battery module 31, and then is heated while flowing through the refrigerant jacket 50. Since the gap G1 is formed between the refrigerant jacket 50 and the supply pipe 60, it is possible to prevent the refrigerant flowing through the supply pipe 60 from being heated by heat exchange with the refrigerant flowing through the refrigerant jacket 50.

As shown in FIG. 10, a gap G2 is also formed between the refrigerant jacket 50 and the discharge pipe 70. A step portion 59 is provided around the discharge port 52 of the refrigerant jacket 50, and the step portion 59 around the discharge port 52 abuts against the upper surface of the discharge pipe 70 to form the gap G2.

The refrigerant heated by the refrigerant jacket 50 flows through the discharge pipe 70. Since the gap G2 is formed between the refrigerant jacket 50 and the discharge pipe 70, it is possible to prevent the refrigerant flowing through the refrigerant jacket 50 from being heated by heat exchange with the refrigerant flowing through the discharge pipe 70.

Although one embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the embodiment described above, the distribution pipe 42 is arranged in front of the battery module 31, and the aggregation pipe 43 is arranged behind the battery module 31, but the present invention is not limited thereto. The distribution pipe 42 is arranged behind the battery module 31, and the aggregation pipe 43 is arranged in front of the battery module 31. In this case, the supply pipe 60 is arranged rearward of the central portion 50c of the refrigerant jacket 50, and the discharge pipe 70 is arranged forward of the central portion 50c of the refrigerant jacket 50.

In this specification, at least the following matters are described. In the parentheses, the corresponding constituent elements and the like in the embodiment described above are shown as an example, but the present invention is not limited thereto.
(1) A battery pack (battery pack 7) to be mounted on a vehicle (vehicle 1), the battery pack including:
   a battery case (battery case 30);
   a plurality of battery modules (battery modules 31) placed on the battery case such that a longitudinal direction of each of the battery modules is a front-rear direction of the vehicle, at least two battery modules being arranged side by side in a vehicle width direction, and at least two battery modules being arranged side by side in the front-rear direction;
   a plurality of battery cooling portions (battery cooling portions 41), through which a refrigerant flows, arranged below the at least two battery modules (battery modules 31A, 31B and 31C) arranged side by side in the front-rear direction;
   a distribution pipe (distribution pipe 42) arranged on one side in the front-rear direction with respect to the plurality of battery modules and configured to distribute the refrigerant to the plurality of battery cooling portions; and
   an aggregation pipe (aggregation pipe 43) arranged on other side in the front-rear direction with respect to the plurality of battery modules and configured to aggregate the refrigerant discharged from the plurality of battery cooling portions,
   in which each of the plurality of battery cooling portions includes:
      a refrigerant jacket (refrigerant jacket 50) configured to cool the at least two battery modules arranged side by side in the front-rear direction;
      a supply pipe (supply pipe 60) connected to the refrigerant jacket and the distribution pipe, and configured to supply the refrigerant to the refrigerant jacket; and
      a discharge pipe (discharge pipe 70) connected to the refrigerant jacket and the aggregation pipe, and configured to discharge the refrigerant from the refrigerant jacket,
   in which the refrigerant jacket, the supply pipe, and the discharge pipe each have a flat shape that is short in an upper-lower direction,
   in which the supply pipe is arranged below the refrigerant jacket, and is connected to a supply port (supply port 51) provided in a central portion (central portion 50c) of the refrigerant jacket in the front-rear direction, and
   in which the discharge pipe is arranged below the refrigerant jacket, and is connected to a discharge port (discharge port 52) provided in the central portion of the refrigerant jacket.

According to (1), since the supply port and the discharge port are provided in the central portion of the refrigerant jacket, the plurality of battery modules arranged side by side in the front-rear direction can be uniformly cooled, and a variation in temperature can be prevented. Further, since the supply pipe and the discharge pipe are arranged below the refrigerant jacket, the supply pipe and the discharge pipe do not interfere with the battery modules and a connection member connecting the battery modules, and a layout performance inside the battery pack can be improved.
(2) The battery pack according to (1),
   in which the refrigerant jacket includes:
      a front flow path (front flow path 54) configured to allow the refrigerant introduced from the supply port provided in the central portion to flow to a front end portion (front end portion 50f), and allow the refrigerant to return at the front end portion and to flow from the front end portion to the discharge port provided in the central portion; and
      a rear flow path (rear flow path 55) configured to allow the refrigerant introduced from the supply port provided in the central portion to flow to a rear end portion (rear end portion 50r), and allow the refrigerant to return at the rear end portion and to flow from the rear end portion to the discharge port provided in the central portion.

According to (2), a variation in the temperatures of the plurality of battery modules arranged side by side in the front-rear direction can be prevented.
(3) The battery pack according to (2),
   in which the three battery modules are arranged side by side in the front-rear direction,
   in which the front flow path of the refrigerant jacket is configured to cool a front battery module (battery module 31A) and a central battery module (battery module 31B) among the three battery modules arranged side by side in the front-rear direction, and
   in which the rear flow path of the refrigerant jacket is configured to cool the central battery module and a rear battery module (battery module 31C) among the three battery modules arranged side by side in the front-rear direction.

According to (3), it is possible to prevent a variation in temperature among the three battery modules arranged side by side in the front-rear direction.
(4) The battery pack according to any one of (1) to (3),
   in which the supply port of the refrigerant jacket is open downward, and
   in which the supply pipe is provided with an opening (opening 61), which is open upward and is connected to the supply port of the refrigerant jacket, on an upper surface of the supply pipe.

According to (4), a height in the upper-lower direction of a connection portion between the refrigerant jacket and the supply pipe can be reduced.
(5) The battery pack according to any one of (1) to (4),
   in which the discharge port of the refrigerant jacket is opened downward, and
   in which the discharge pipe is provided with an opening (opening 71), which is open upward and is connected to the discharge port of the refrigerant jacket, on an upper surface of the discharge pipe.

According to (5), the height in the upper-lower direction of a connection portion between the refrigerant jacket and the discharge pipe can be reduced.
(6) The battery pack according to any one of (1) to (5),
   in which a gap (gap G1) is formed between the refrigerant jacket and the supply pipe.

According to (6), heat exchange between the refrigerant flowing through the supply pipe and the refrigerant flowing through the refrigerant jacket heated by heat exchange with the battery module is prevented. Accordingly, it is possible to prevent heating of the refrigerant before the refrigerant is introduced into the refrigerant jacket.
(7) The battery pack according to any one of (1) to (6),
   in which a gap (gap G2) is formed between the refrigerant jacket and the discharge pipe.

According to (7), heat exchange between the refrigerant flowing through the discharge pipe and the refrigerant flowing through the refrigerant jacket is prevented. Accordingly, it is possible to prevent the refrigerant flowing through the refrigerant jacket from being heated by heat exchange with the refrigerant flowing through the discharge pipe.

What is claimed is:

1. A battery pack to be mounted on a vehicle, the battery pack comprising:
a battery case;
a plurality of battery modules placed on the battery case such that a longitudinal direction of each of the battery modules is a front-rear direction of the vehicle, at least two battery modules being arranged side by side in a vehicle width direction, and at least two battery modules being arranged side by side in the front-rear direction;
a plurality of battery cooling portions, through which a refrigerant flows, arranged below the at least two battery modules arranged side by side in the front-rear direction;
a distribution pipe arranged on one side in the front-rear direction with respect to the plurality of battery modules and configured to distribute the refrigerant to the plurality of battery cooling portions; and
an aggregation pipe arranged on other side in the front-rear direction with respect to the plurality of battery modules and configured to aggregate the refrigerant discharged from the plurality of battery cooling portions,
wherein each of the plurality of battery cooling portions includes:
a refrigerant jacket configured to cool the at least two battery modules arranged side by side in the front-rear direction;
a supply pipe connected to the refrigerant jacket and the distribution pipe, and configured to supply the refrigerant to the refrigerant jacket; and
a discharge pipe connected to the refrigerant jacket and the aggregation pipe, and configured to discharge the refrigerant from the refrigerant jacket,
wherein the refrigerant jacket, the supply pipe, and the discharge pipe each have a flat shape that is short in an upper-lower direction,
wherein the supply pipe is arranged below the refrigerant jacket, and is connected to a supply port provided in a central portion of the refrigerant jacket in the front-rear direction, and
wherein the discharge pipe is arranged below the refrigerant jacket, and is connected to a discharge port provided in the central portion of the refrigerant jacket.

2. The battery pack according to claim 1,
wherein the refrigerant jacket includes:
a front flow path configured to allow the refrigerant introduced from the supply port provided in the central portion to flow to a front end portion, and allow the refrigerant to return at the front end portion and to flow from the front end portion to the discharge port provided in the central portion; and
a rear flow path configured to allow the refrigerant introduced from the supply port provided in the central portion to flow to a rear end portion, and allow the refrigerant to return at the rear end portion and to flow from the rear end portion to the discharge port provided in the central portion.

3. The battery pack according to claim 2,
wherein the three battery modules are arranged side by side in the front-rear direction,
wherein the front flow path of the refrigerant jacket is configured to cool a front battery module and a central battery module among the three battery modules arranged side by side in the front-rear direction, and
wherein the rear flow path of the refrigerant jacket is configured to cool the central battery module and a rear battery module among the three battery modules arranged side by side in the front-rear direction.

4. The battery pack according to claim 1,
wherein the supply port of the refrigerant jacket is open downward, and
wherein the supply pipe is provided with an opening, which is open upward and is connected to the supply port of the refrigerant jacket, on an upper surface of the supply pipe.

5. The battery pack according to claim 1,
wherein the discharge port of the refrigerant jacket is opened downward, and
wherein the discharge pipe is provided with an opening, which is open upward and is connected to the discharge port of the refrigerant jacket, on an upper surface of the discharge pipe.

6. The battery pack according to claim 1,
wherein a gap is formed between the refrigerant jacket and the supply pipe.

7. The battery pack according to claim 1,
wherein a gap is formed between the refrigerant jacket and the discharge pipe.
